(19) United States
(12) Patent Application Publication
(10) Pub. No.: US 2026/0030844 A1
(43) Pub. Date: Jan. 29, 2026

(54) REMOTE APPAREL FITTING

(71) Applicant: SpreeAI Corporation, Incline Village, NV (US)

(72) Inventors: John Imah, Los Angeles, CA (US); Aayush Bansal, Pittsburgh, PA (US); Minh Phuoc Vo, Alameda, CA (US)

(73) Assignee: SpreeAI Corporation, Incline Village, NV (US)

(21) Appl. No.: 18/787,363

(22) Filed: Jul. 29, 2024

(51) Int. Cl. G06T 19/00; G06T 7/60

(52) U.S. Cl. CPC G06T 19/00; G06T 7/60; G06T 2207/30196; G06T 2210/16

(57) ABSTRACT

In one implementation of remote apparel fitting, a processing device receives an input image that depicts a subject person (e.g., an online consumer). A selection of a clothing item is also received. For example, the subject person is browsing an online catalog of clothing items to find clothing items (e.g., shirts) that fit well. A machine-learning model uses the image to determine measurements of the subject person that correlate to one or more dimensions of the clothing item. In some implementations, the machine-learning model determines the measurements after generating a mesh model of the subject person. The machine-learning model is then used to determine the fit of the clothing item on the subject person. The processing device then presents a composite image that represents the fit of the clothing item on the subject person overlayed on a reproduced image of the subject person wearing the clothing item.

### BACKGROUND

The world of clothing sizes is filled with significant variations across different brands, and even within the same brand. This means that a person might wear one size of a particular clothing item from a certain brand and find it fits perfectly, but the same size from another brand might not fit well at all. Traditionally, shoppers dealt with this issue by trying on clothing items in physical retail locations such as department stores. However, with the increasing trend of purchasing clothing online or from remote marketplaces, people have lost the assurance of confidently selecting clothing items and sizes that fit well.

### SUMMARY

Techniques and systems for remote apparel fitting are described. In one example, a processing device receives an input image that depicts a subject person (e.g., an online consumer), preferably from a front- or side-facing perspective. A selection of a clothing item is also received. For example, the person is browsing an online catalog of clothing items and trying to find clothing items (e.g., shirts) that fit well. A machine-learning model uses the image to determine measurements of the subject person that correlate to one or more dimensions of the clothing item. In some implementations, the machine-learning model determines the measurements after generating a mesh model of the subject person. The machine-learning model is then used to determine the fit of the clothing item on the subject person. The processing device then presents a composite image that represents the fit of the clothing item on the subject person overlayed on a reproduced image of the subject person wearing the clothing item.

This Summary introduces a simplified selection of concepts described below in the Detailed Description. As such, this Summary is not intended to identify essential features of the claimed subject matter or to aid in determining its scope.

### BRIEF DESCRIPTION OF THE DRA WINGS

The detailed description is described regarding the accompanying figures. Entities represented in the figures indicate one or more entities; thus, reference is made interchangeably to single or plural forms of the entities in the discussion.

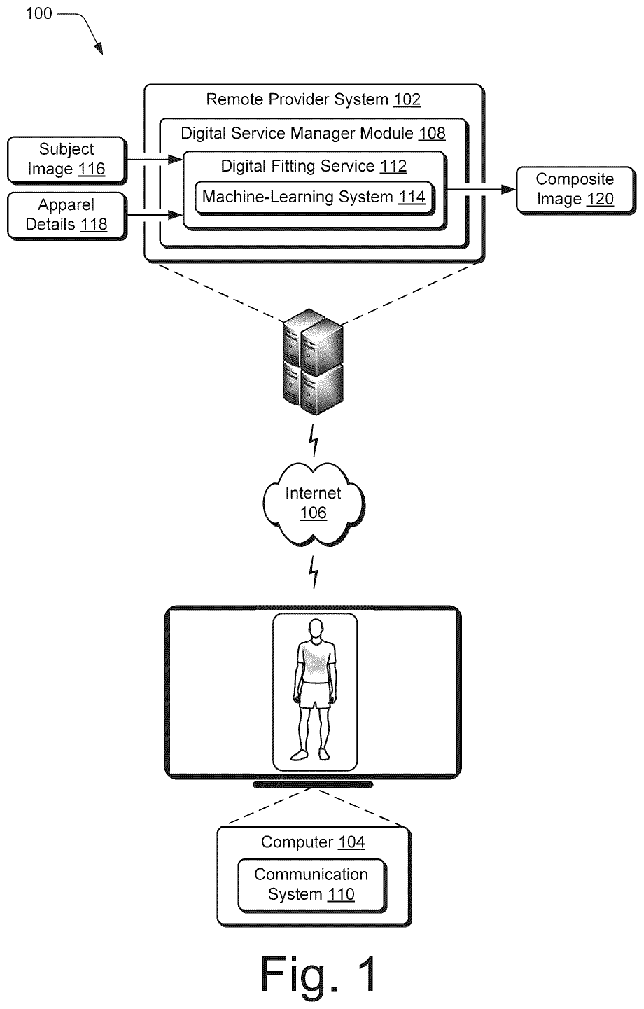

FIG. 1 illustrates a digital medium environment in an example implementation that is operable to employ remote apparel fitting techniques as described herein.

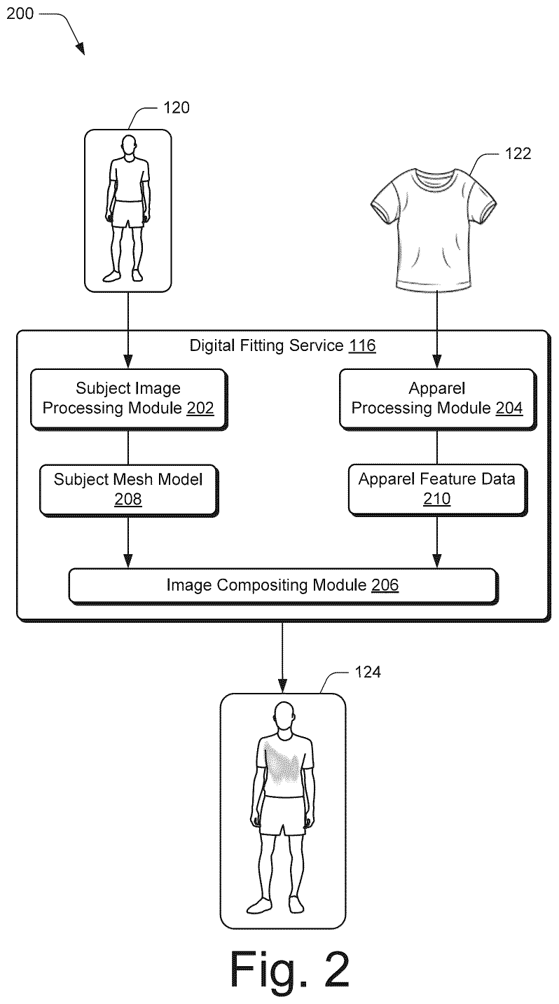

FIG. 2 depicts a system in an example implementation that shows the operation of a digital fitting service of FIG. 1 in greater detail, employing the techniques described herein.

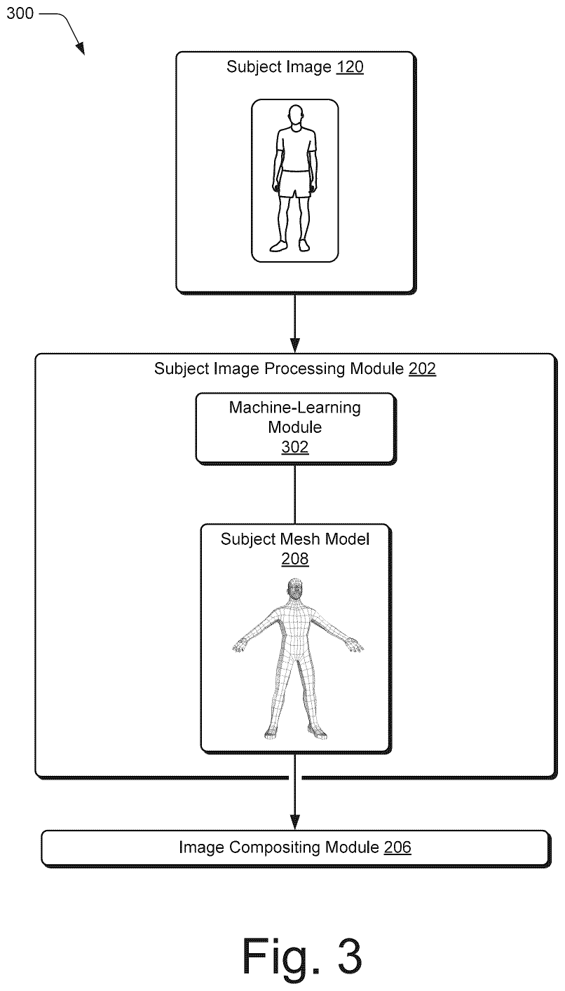

FIG. 3 depicts a system in an example implementation showing the operation of a subject image processing module of the digital fitting service of FIG. 2 in greater detail.

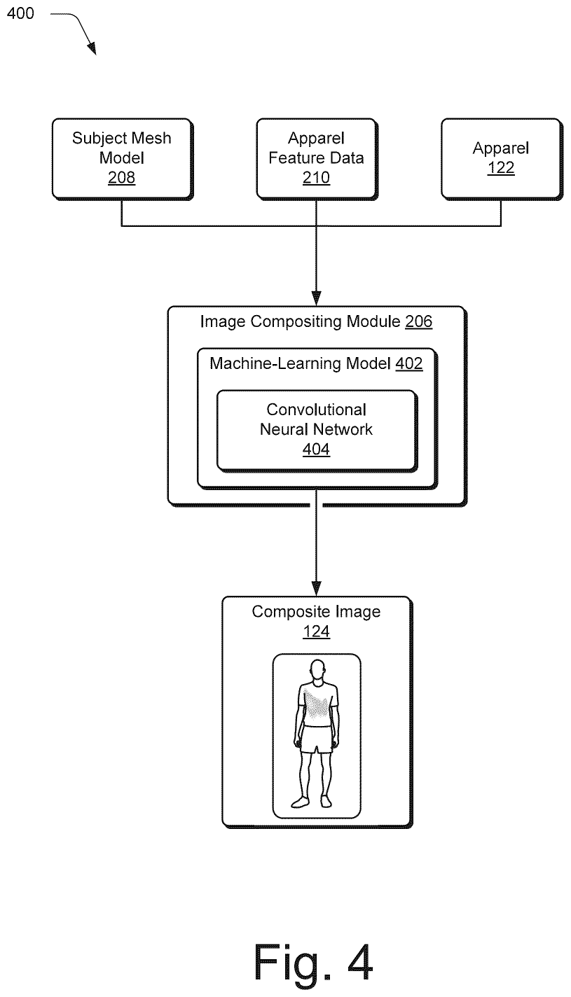

FIG. 4 depicts a system in an example implementation showing the operation of an image compositing module of the digital fitting service of FIG. 2 in greater detail.

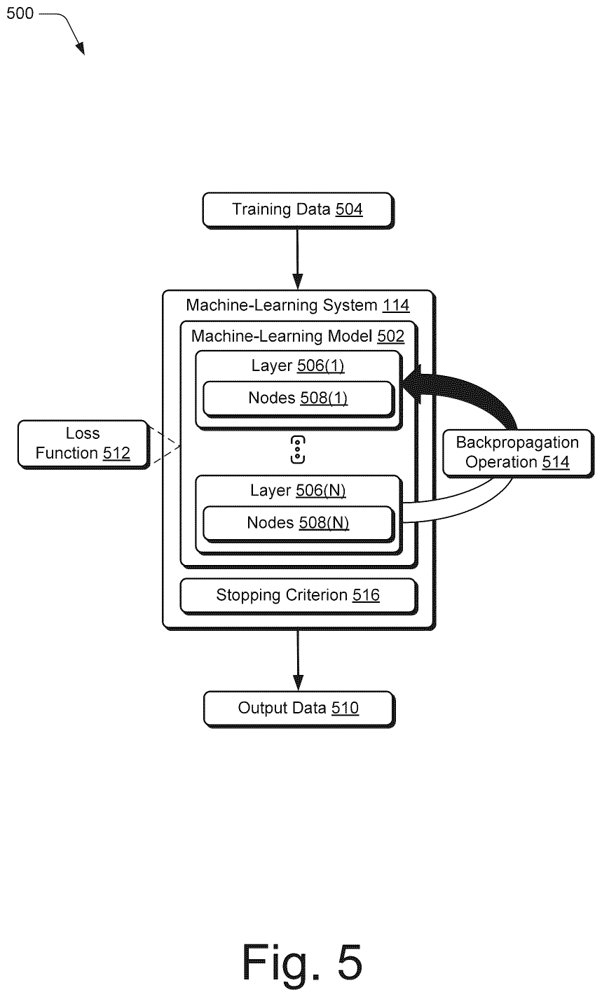

FIG. 5 depicts a system and procedure in an example implementation for training a machine-learning model.

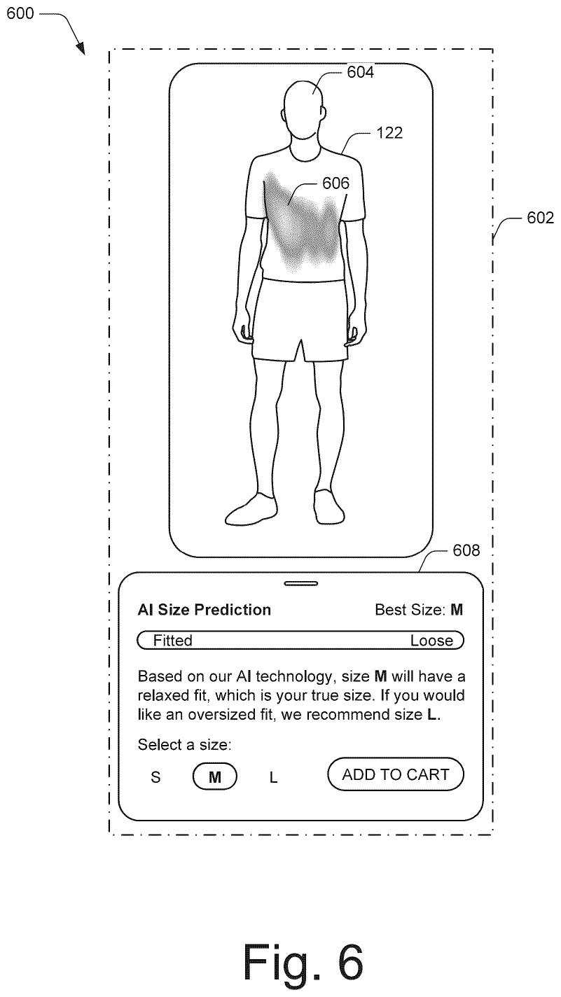

FIG. 6 depicts an example implementation of a composite image displayed to a user of a digital fitting service.

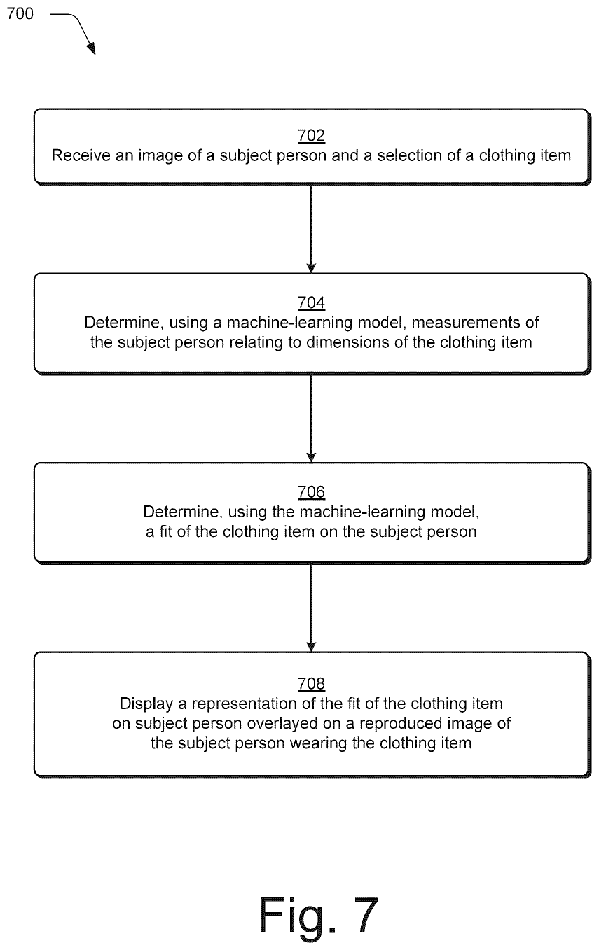

FIG. 7 is a flow diagram depicting an algorithm as a step-by-step procedure in an example implementation of operations performable for accomplishing a result of remote apparel fitting.

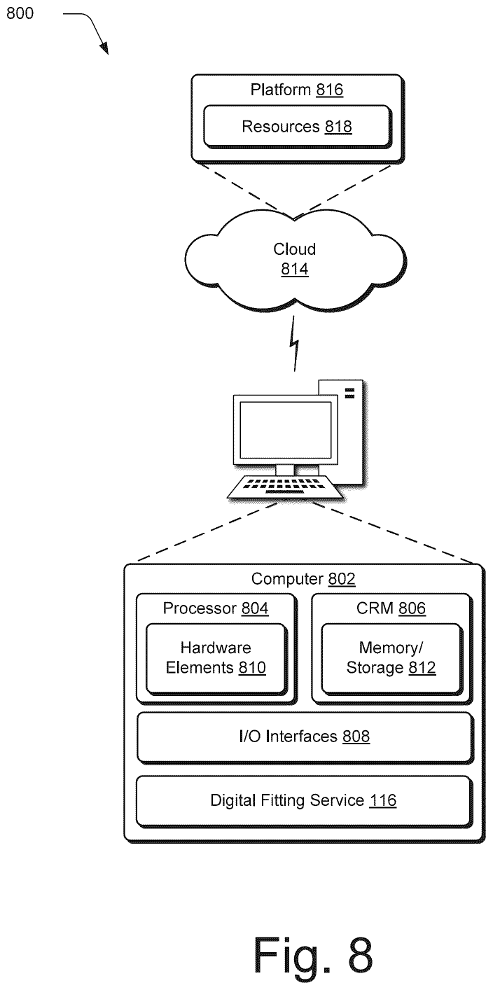

FIG. 8 illustrates an example system including various components of an example device that can be implemented as any type of computing device as described and/or utilized concerning the previous figures to implement embodiments of the techniques described herein.

### DETAILED DESCRIPTION

### Overview

Ordering clothes online can be both convenient and frustrating. On one hand, it offers unmatched convenience and the ability to browse numerous options. However, this convenience comes with its fair share of frustrations. For instance, one of the biggest challenges is being unable to physically try on the clothes before purchasing. Sizing discrepancies between brands and even different styles within the same brand make it difficult to find the right fit. This often leads to the inconvenience of returning or exchanging items, incurring additional costs, and wasting time.

Furthermore, online clothes shopping is challenging because it is difficult to accurately assess color, material quality, and how clothes drape from online photos. The limitations of digital images mean that items can look vastly different in person than they did on the screen. As a result, it is challenging to predict how clothes will fit and look without being able to try them on, which makes online clothes shopping a daunting and often disappointing experience.

Retailers and manufacturers often provide sizing charts that display a garment's measurements in different sizes. These charts typically include key measurements like chest, waist, hips, inseam, and/or sleeve length, and indicate which size (e.g., small(S), medium (M), large (L), etc.) corresponds to each range of body measurements. Sizing charts are intended to assist consumers, especially online shoppers, choose well-fitting clothes. However, sizing charts can be difficult to navigate because sizing varies across brands and body types. Because they generally focus on a few key measurements, sizing charts do not account for other factors like body shape, height, and personal preferences.

In contrast, the described techniques for remote apparel fitting provide online shoppers with greater confidence in selecting clothing items and sizes that fit well and match their preferences. The remote fitting techniques use a machine-learning model to determine a shopper's dimensions from a single uploaded or saved image of the person. Together with measurement details of the selected clothing item, the machine-learning model generates an image or three-dimensional representation of the clothing item on a digital representation of the shopper. In addition, the machine-learning model provides a heat map or other indication showing the garment's fit on different portions of the user's body. For example, the heat map indicates areas where a shirt may be tight (e.g., on the arms) and/or loose (e.g., at the chest). In this way, users can make online purchases more confidently, find clothes that fit them better, and reduce the need to return purchases.

The following discussion describes an example environment that employs the techniques described herein. Example procedures are also described as performable in the example environment and other environments. Consequently, the performance of the example procedures is not limited to the example environment, and the example environment is not limited to the performance of the example procedures.

### Example Video Compositing Environment

FIG. 1 illustrates a digital medium environment 100 in an example implementation that is operable to employ remote apparel fitting techniques as described herein. The illustrated digital medium environment 100 includes a remote provider system 102 and a computer 104 that are communicatively coupled, one to another, via the Internet 106 or another wired or wireless network. Computing systems for the remote provider system 102 and the computer 104 are configurable in various ways. For instance, computer 104 is associated with a user, and remote provider system 102 is a remote computing system (e.g., one or more servers) configured to employ the described techniques and systems for remote apparel fitting.

A computing system, for instance, is configurable as a desktop computer, laptop computer, mobile device (e.g., assuming a handheld configuration such as a tablet or mobile phone), server, and so forth. Thus, the remote provider system 102 or the computer 104 can range from a full-resource device with substantial memory and processor resources (e.g., servers and personal computers) to a low-resource device with limited memory and/or processing resources (e.g., some mobile devices). Additionally, although a single computing device is shown for the computer 104 and described in instances in the following discussion, a computing system is also representative of a plurality of different devices, such as multiple servers utilized by a business to perform operations “over the cloud” for the remote provider system 102 and as further described in relation to FIG. 8.

The remote provider system 102 includes a digital service manager module 108 implemented using hardware and software resources (e.g., a processing device and computer-readable storage medium) to support one or more digital services (e.g., an online marketplace). The digital services are made available remotely via the Internet 106 to computing devices (e.g., computer 104).

The digital services are scalable through implementation by the hardware and software resources and support a variety of functionalities, including accessibility, verification, real-time processing, analytics, load balancing, and so forth. Examples of digital services include a social media service, online marketplace, streaming service, digital content repository service, content collaboration service, and so on. Accordingly, in the illustrated example, a communication system 110 (e.g., browser, network-enabled application, and so on) is utilized by the computer 104 to access digital services via the Internet 106. The result of processing using the digital services is then returned to the computer 104 via the Internet 106.

In the illustrated digital medium environment 100, the digital services include a digital fitting service 112 for assisting online purchasers in finding clothes and sizes that fit well. For example, the digital fitting service 112 uses a machine-learning system 114 to process a subject image 116 and apparel details 118 to generate a composite image 120. Given a subject image 116 capturing an image of the purchaser (or another consumer), the digital fitting service 112 generates the composite image 120 that includes a digital representation of the purchaser in the selected clothing item and an indication of its fit on the purchaser.

The composite image 120 readily depicts the purchaser with alternate sizes or clothing items upon the user's interaction with a user interface (UI) of the computer 104. Visually, the digital fitting service 112 swaps the original clothing in subject image 116 with a different clothing item realistically and plausibly and provides an indication of its fit on the user.

As previously described, conventional online marketplaces generally just provide a sizing chart with limited measurements to assist users in selecting an appropriate size and/or determining if the clothing item will fit the user as desired. In the described remote apparel fitting techniques, however, image compositing gives users greater confidence in selecting clothing sizes and items that fit them well and match a desired style.

To do so, the digital fitting service 112 is configurable to employ the machine-learning system(s) 114 to determine a user's dimensions (e.g., chest size, shoulder width, etc.) from a single uploaded image (e.g., the subject image 116). The user's dimensions are used to generate a mesh model of the user, which is then used by the same machine-learning system 114 or another machine-learning system 114 to generate the composite image 120 of the user wearing the selected clothing item. This machine-learning system 114 also uses the apparel details 118 (e.g., various measurements) to determine a fit of the selected clothing item on the mesh model representation of the user. The composite image 120 provides a digital representation of the user (based on the subject image 116) or a mannequin wearing the selected clothing item with similar body proportions. The composite image 120 also indicates the clothing's fit (e.g., using a heat map showing areas of tightness or looseness on different portions of the digital body). Further discussion of these and other examples is included in the following section and shown in the corresponding figures.

In general, functionality, features, and concepts described in relation to the examples above and below are employed in the context of the example procedures described in this section. Further, functionality, features, and concepts described in relation to different figures and examples in this document are interchangeable among one another and are not limited to implementation in the context of a particular figure or procedure. Moreover, blocks associated with different representative procedures and corresponding figures herein are applicable together and/or combinable in different ways. Thus, individual functionality, features, and concepts described in relation to different example environments, devices, components, figures, and procedures herein are usable in any suitable combinations and are not limited to the particular combinations represented by the enumerated examples in this description.

### Example Digital Fitting

FIG. 2 depicts a system 200 in an example implementation showing the operation of the digital fitting service 112 of FIG. 1 as employing the techniques described herein. The digital fitting service 112 is configurable to implement a pipeline to address technical challenges, supporting the generation of a composite figure that indicates how a particular clothing item fits on a subject. To do so, the digital fitting service 112 employs a subject image processing module 202, an apparel processing module 204, and an image compositing module 206.

The subject image processing module 202 is configured to process the subject image 116 to generate a subject mesh model 208. In particular, the subject image processing module 202 uses a machine-learning model to extract the subject's measurements (e.g., chest width, torso length, etc.) from the subject image 116 and generate the subject mesh model 208. The subject mesh model 208 is proportioned to match the extracted or determined measurements of the subject. The generation of the subject mesh model is further described in relation to FIG. 3.

The apparel processing module 204 is configured to analyze the selected apparel 122 and generate or look up apparel feature data 210. The apparel feature data 210 is generally known by the digital fitting service 112 or readily available for lookup by the apparel processing module 204. In one implementation, the apparel processing module 204 looks up at least some of the apparel feature data 210 (e.g., a minimum set of measurements) for the selected apparel 122 and extrapolates or determines other apparel feature data 210 based on the provided data. The apparel feature data 210 includes different measurements (e.g., sleeve length, wrist diameter, neck opening diameter, torso length, inseam, waist circumference) and characteristics (e.g., stretchiness, material, drape, color) of the selected apparel 122.

Outputs of the subject image processing module 202 (e.g., the subject mesh model 208) and the apparel processing module 204 (e.g., apparel feature data 210) are then received as inputs by the image compositing module 206 to generate the composite image 124. In particular, the image compositing module 206 is employed to render the subject based on the subject mesh model 208 in relation to the apparel feature data 210 to provide an indication of the apparel's fit on the subject. Compared with conventional techniques, the digital fitting service 112 exhibits improved remote fitting to improve online shopping experiences and reduce the hassle associated with poor fitting purchases.

FIG. 3 depicts a system 300 in an example implementation showing an operation of a subject image processing module 202 of the digital fitting service 112 of FIG. 2 in greater detail. The subject image processing module 202 includes a machine-learning module 302 configured to generate a subject mesh model 208 from the subject image 116. The machine-learning module 302 uses a skinned multi-person linear (SMPL) model to generate the subject mesh model 208.

An SMPL model is a parametric three-dimensional (3D) body model that utilizes machine learning. A parametric model uses a fixed number of parameters to represent the data (e.g., mesh models) it describes. In other words, these parameters are essentially the knobs turned to adjust the model's fit to the data. Parametric models use a finite or predetermined set of parameters. Because they have a fixed number of parameters, parametric models are often simpler to train and require less data than non-parametric models.

An SMPL model is a powerful tool used to represent human bodies in computer graphics and animation. In particular, SPML models use a blend of linear skinning and blend shapes to represent a wide range of human body shapes and poses. Linear skinning uses weights to deform a base mesh according to a skeleton, allowing for basic body movements. Blend shapes are pre-defined shapes added to the base mesh to capture details like muscle bulges or wrinkles in clothing. The SMPL model of the machine-learning module 302 captures various body shapes and poses. In particular, the machine-learning module 302 uses a relatively small number of parameters to represent complex body shapes, making it efficient for storage and real-time processing.

The parameters that control the weights and blend shapes in SMPL models are learned from a large dataset of 3D body scans, allowing them to represent a statistically realistic range of human body shapes. Here, the SMPL model of the machine-learning module 302 is further trained on two-dimensional (2D) images or photographs of individuals to be able to generate body meshes (e.g., the subject mesh model 208) from uploaded images (e.g., the subject image 116). The machine-learning module 302 learns the statistical relationships between the pose, shape, and appearance of the human body in the 2D images. The learned parameters are then used to define the weights and blend shapes within the SMPL model.

The subject mesh model 208 is a 3D representation of the human body (e.g., the subject in the subject image 116) made up of polygons (e.g., triangles). The polygons connect to form a surface that defines the shape and volume of the body. In other words, the subject mesh model 208 provides a realistic body shape for the subject (e.g., consumer) to allow their measurements to be extracted or determined for the digital fitting.

Low-poly models use fewer polygons, making them simpler and better suited for real-time applications where performance is crucial. High-poly models have a much higher polygon count, resulting in finer details and a more realistic appearance, but they require more processing power to render. Static meshes represent a fixed pose of the human body, while rigged meshes have a skeletal structure embedded within them, allowing for animation and various poses. In some variations, mesh models are textured with images (e.g., skin textures) to add details and realism. The machine-learning module 302 generates low-poly, fixed-pose subject mesh models 208 in one implementation.

FIG. 4 depicts a system 400 in an example implementation showing an operation of the image compositing module 206 of the digital fitting service 112 of FIG. 2 in greater detail. The image compositing module 206 includes a machine-learning model 402 with a convolutional neural network 404. The image compositing module 206 receives as inputs the subject mesh model 208, the apparel feature data 210, and an image or digital representation of the apparel 122, which are provided to the machine-learning model 402.

The machine-learning model 402 utilizes the convolutional neural network 404 to perform a fitting analysis and image compositing based on generative image models. The convolutional neural network 404 uses the subject mesh model 208 and the apparel feature data 210 to generate or determine a fit of the apparel 122 on the subject. For example, the fit data is generated as a series of difference measurements at key points of interest in a fitting of the apparel. For example, the convolutional neural network 404 generates a heat map that includes areas where the apparel 122 fits well, tightly, or loosely. The heat map can be in a grayscale or color scale and displayed with a key to illustrate the fitness of the apparel 122 in different regions of the subject's body. In other implementations, the fit data is represented as points of interest that indicate areas of a tight or loose fit. For example, at each major area of poor fitting a visual icon (e.g., a dot) is displayed that can be selected or hovered over to display information about the fit at or around that body region.

The convolutional neural network 404 uses the subject mesh model 208 and the apparel 122 to generate the composite image 124 that illustrates the subject wearing the selected clothing item (along with the fitting data). In one implementation, the convolutional neural network 404 is a multi-view convolutional neural network (MVCNN) that uses multiple 2D images of the subject mesh model 208 from different viewpoints as input. The MVCNN is trained on a large dataset of mesh models and their corresponding multi-view images. The trained convolutional neural network 404 generates a new image of the subject mesh model 208 wearing the apparel 122 from a viewpoint that a preferred view (e.g., front view) of the apparel 122 and its fit on the subject, even if that view was not included in the training data or the original subject image 116.

In another implementation, the machine-learning model 402 uses a generative adversarial network (GAN) to generate the composite image 124. A generator network takes the subject mesh model 208 and the apparel 122 as inputs and creates a photorealistic image of the subject wearing apparel 122. A discriminator network receives both real images of mesh models and the generated images, trying to distinguish between the two. Through an adversarial training process, the generator becomes better at creating images that fool the discriminator, resulting in increasingly realistic outputs. In other implementations, the image compositing module 206 uses rasterization to transform the 3D subject mesh model 208 into a 2D image with the apparel 122 or neural radiance fields to generate the composite image 124.

FIG. 5 depicts a system and procedure in an example implementation 500 for training a machine-learning model 502 as part of the machine-learning system 114 of FIG. 1. The machine-learning model 502 is illustrated as implemented as part of the machine-learning system 114. The machine-learning system 114 is representative of functionality to generate training data 504, use the generated training data 504 to train the machine-learning model 502, and/or use the trained machine-learning model 502 as implementing the functionality described herein.

A machine-learning model 502 refers to a tunable computer representation (e.g., through training and retraining) based on inputs without being actively programmed by a user to approximate unknown functions, automatically and without user intervention. In particular, the term machine-learning model includes a model that utilizes algorithms to learn from and make predictions on known data by analyzing training data to learn and relearn to generate outputs that reflect patterns and attributes of the training data. Examples of machine-learning models include neural networks, convolutional neural networks (CNNs), long short-term memory (LSTM) neural networks, generative adversarial networks (GANs), decision trees, support vector machines, linear regression, logistic regression, Bayesian networks, random forest learning, dimensionality reduction algorithms, boosting algorithms, deep learning neural networks, etc.

In this context, the machine-learning model 502 employs a diffusion model. A “diffusion model” is a generative machine-learning model for digital content creation (e.g., composite images 124). To train the diffusion model, noise is added to training data samples until the data within the training data samples is obscured. The diffusion model is then trained self-supervised to reverse this process based on training data with a text prompt describing the digital content to be created to generate data samples as the digital content corresponding to the text prompt. To train the diffusion model, the underlying machine-learning model 502 is provided with training data 504 that includes examples of images to train and retrain the model to predict the image to be generated.

The machine-learning model 502 also employs a parametric model.

In the illustrated example, the machine-learning model 502 is configured using a plurality of layers 506(1), . . . , 506(N) having, respectively, a plurality of nodes 508(1), . . . , 508(N). The plurality of layers 506(1)-506(N) are configurable to include an input layer, an output layer, and one or more hidden layers. Calculations are performed by the nodes 508(1)-508(N) within the layers via hidden states through a system of weighted connections that are “learned” during training to implement a variety of tasks (e.g., caption generation).

To train the machine-learning model 502, training data 504 is received that provides examples of “what is to be learned” by the machine-learning model 502, i.e., as a basis to learn patterns from the data. The machine-learning model 502, for instance, collects and preprocesses the training data 504 that includes input features and corresponding target labels, i.e., of what is exhibited by the input features. The machine-learning system 114 then initializes the parameters of the machine-learning model 502, which the machine-learning system 114 uses as internal variables to represent and process information during training and represent interferences gained through training. In an implementation, the training data 504 is separated into batches to improve the processing and optimization efficiency of the parameters during training.

The training data 504 is then received as input and used to generate predictions based on the current state of parameters of layers 506(1)-506(N) and corresponding nodes 508(1)-508(N) of the model. The machine-learning model 502 outputs its result as output data 510. Output data 510 describes an outcome of the task (e.g., generating a composite image).

Training the machine-learning model 502 includes calculating a loss function 512 to quantify a loss associated with operations performed by nodes 508 of the machine-learning model 502. For instance, calculating the loss function 512 includes comparing a difference between predictions specified in the output data 510 with target labels specified by the training data 504. The loss function 512 is configurable in various ways, including regression, the quadratic loss function as part of a least squares technique, and so forth.

Calculating the loss function 512 also includes using a backpropagation operation 514 to minimize the loss function 512, thereby training the parameters of the machine-learning model 502. Minimizing the loss function 512 includes adjusting the weights of the nodes 508(1)-508(N) to minimize the loss and thereby optimize the performance of the machine-learning model 502 for a particular task. The adjustment is determined by computing a gradient of the loss function 512, which indicates a direction to be used to adjust the parameters for minimizing the loss. The parameters of the machine-learning model 502 are then updated based on the computed gradient.

This process continues over several iterations until a stopping criterion 516 is met. The stopping criterion 516 is employed by the machine-learning system 114 in this example to reduce overfitting of the machine-learning model 502, reduce computational resource consumption, and promote an ability to address previously unseen data, i.e., that is not included specifically as an example in the training data 504. Examples of a stopping criterion 516 include but are not limited to a predefined number of epochs, validation loss stabilization, achievement of a performance improvement threshold, or based on performance metrics such as precision and recall.

FIG. 6 depicts an example implementation 600 of a composite image displayed to a user of a digital fitting service in a user interface 602. The user interface 602 includes a composite image 604 with a heat map 606 and an informational element 608. In other implementations, the user interface 602 includes additional or fewer components.

The composite image 604 represents the subject (e.g., online purchaser) wearing the selected apparel 122 with the heat map 606. The subject representation can include a mannequin image with body proportions based on the subject mesh model 208. In other implementations, the subject representation reproduces the user based on the subject image 116. The illustrated implementation 600 provides a front-facing view of the composite image 604, but different-facing views are provided in different implementations. In other implementations, the composite image 604 can be rotated or seen from different perspectives.

The heat map 606 visualizes tight, loose, or well-fitting areas for the apparel 122 on the user. In the illustrated implementation 600, the heat map 606 is grayscale but uses a color scale in other implementations. The informational element 608 provides a visual key to interpret the heat map 606. In other implementations, the heat map 606 is replaced with visual markers of loose or tight fitting areas.

The informational element 608 includes an “AI size prediction” with a recommended best size of the apparel 122 for the user (e.g., “M” for Medium) and a summary of the fitting (e.g., “Based on our AI technology, size M will have a relaxed fit, which is your true size. If you would like an oversize fit, we recommend size L.”). The informational element 608 also includes an option for the user to select a different size of the apparel 122 (with the current selection highlighted or visually indicated) and another user-interface (UI) element for the user to add the apparel 122 to a shopping cart (e.g., “Add to cart”). In other implementations, the informational element 608 includes additional or fewer UI elements, including, for example, an instant purchase button, a preview of similar clothing items with a better fit, or an option to change the color or pattern of the apparel 122.

### Example Remote Fitting Procedures

The following discussion describes remote fitting techniques that are implementable utilizing the described systems and devices. Aspects of each procedure are implemented in hardware, firmware, software, or a combination thereof. The procedures are shown as a set of blocks that specify operations performable by hardware and are not necessarily limited to the orders shown for performing the operations by the respective blocks. Blocks of the procedures, for instance, specify operations programmable by hardware (e.g., processor, microprocessor, controller, firmware) as instructions, thereby creating a special-purpose machine for carrying out an algorithm as illustrated by the flow diagram. As a result, the instructions are stored on a computer-readable storage medium that causes the hardware to perform the algorithm, e.g., responsive to the execution of the instructions. In portions of the following discussion, reference will be made to FIGS. 1-6.

FIG. 7 is a flow diagram depicting an algorithm as a step-by-step procedure 700 in an example implementation of operations performable for accomplishing a result of remote apparel fitting. To begin, a processing device receives an image of a subject person and a clothing item selection (block 702). For example, the clothing item selection also indicates a selected size of the clothing item for the remote apparel fitting.

A machine-learning model is then used to determine measurements of the subject person that relate or correspond to the dimensions of the selected clothing item (block 704). The machine-learning model, for example, is a parametric model (e.g., SPML model) that generates a representation of the subject person using a human mesh model with the measurements of the subject person. The clothing item's dimensions (e.g., shoulder width, waist circumference, inseam length, hip circumference, sleeve length, sleeve circumference, collar opening diameter, chest width, chest diameter) are determined or looked up by the processing device.

The machine-learning model (or another machine-learning model) then determines the fit of the clothing item on the subject person (block 706). As another example, the machine-learning model includes a generative adversarial network or a generative diffusion model that generates the reproduced image of the subject person wearing the clothing item based on the human mesh model. The image of the subject person is projected onto the human mesh model to generate the reproduced image, and the clothing item is projected onto the reproduced image of the subject person.

Finally, a representation of the fit of the clothing item on the subject person overlayed on a reproduced image of the subject person wearing the clothing item are displayed by the processing device via a display (block 708). The fit representation, for example, indicates a looseness or tightness of the clothing item in multiple locations vis-à-vis the measurements of the subject person. The fit representation is a heat map (e.g., grayscale or color) with a fitting key in one implementation. The processing device can also provide a textual summary of the fit or a suggestion for a better fit for a different size or clothing item. In one implementation, the reproduced image is three-dimensional or rotatable to allow views of the clothing fit from different perspectives.

### Example System and Device

FIG. 8 illustrates an example system 800, which includes an example computer 802 that represents one or more computing systems and/or devices usable to implement the techniques described herein. This is illustrated through the inclusion of the digital fitting service 112. The computer 802 is configurable, for example, as a service provider server, a device associated with a client (e.g., a client device), an on-chip system, and/or any other suitable computing device or computing system.

The example computer 802, as illustrated, includes a processor 804, one or more computer-readable media 806, and one or more I/O interfaces 808 that are communicatively coupled, one to another. Although not shown, the computer 802 includes a system bus or other data and command transfer system that couples the various components. For example, a system bus includes any combination of different bus structures, such as a memory bus or controller, a peripheral bus, a universal serial bus, and/or a processor or local bus that utilizes various bus architectures. Various other examples are also contemplated, such as control and data lines.

The processor 804 represents the functionality to perform one or more operations using hardware. Accordingly, processor 804 is illustrated as including hardware elements 810 that are configured as processors, functional blocks, and so forth. This includes example implementations in hardware as an application specific integrated circuit or other logic device formed using one or more semiconductors. The hardware elements 810 are not limited by the materials from which they are formed or the processing mechanisms employed therein. For example, processors are comprised of semiconductor(s) and/or transistors (e.g., electronic integrated circuits (ICs)). In such a context, processor-executable instructions are, for example, electronically-executable instructions.

The computer-readable media 806 is illustrated as including memory/storage 812. Memory/storage 812 represents memory or storage capacity associated with one or more computer-readable media. In one example, the memory/storage 812 includes volatile media (such as random access memory (RAM)) and/or nonvolatile media (such as read-only memory (ROM), Flash memory, optical disks, magnetic disks, and so forth). In another example, the memory/storage 812 includes fixed media (e.g., RAM, ROM, a fixed hard drive, and so on) and removable media (e.g., Flash memory, a removable hard drive, an optical disc, and so forth). The computer-readable media 806 is configurable in various ways, as described below.

Input/output interface(s) 808 are representative of functionality to allow a user to enter commands and information to computer 802, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., which employs visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, computer 802 is configurable in various ways to support user interaction, as further described below.

Various techniques are described in the general context of software, hardware elements, or program modules. Generally, such modules include routines, programs, objects, elements, components, data structures, and so forth that perform particular tasks or implement abstract data types. The terms “module,” “functionality,” and “component” as used herein generally represent software, firmware, hardware, or a combination thereof. The features of the techniques described herein are platform-independent, meaning that the techniques are implementable on various commercial computing platforms with various processors.

Implementations of the described modules and techniques are stored on or transmitted across some form of computer-readable media. For example, the computer-readable media includes a variety of media accessible to the computer 802. By way of example, and not limitation, computer-readable media includes “computer-readable storage media” and “computer-readable signal media.”

“Computer-readable storage media” refers to media and/or devices that enable persistent and/or non-transitory information storage in contrast to mere signal transmission, carrier waves, or signals per se. Thus, computer-readable storage media refers to non-signal-bearing media. The computer-readable storage media includes hardware such as volatile and non-volatile, removable and non-removable media, and/or storage devices implemented in a method or technology suitable for storage of information such as computer-readable instructions, data structures, program modules, logic elements/circuits, or other data. Examples of computer-readable storage media include, but are not limited to, RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and which are accessible to a computer.

“Computer-readable signal media” refers to a signal-bearing medium configured to transmit instructions to the hardware of the computer 802, such as via a network. Signal media typically embodies computer-readable instructions, data structures, program modules, or other data in a modulated data signal, such as carrier waves, data signals, or other transport mechanisms. Signal media also includes any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 810 and computer-readable media 806 are representative of modules, programmable device logic, and/or fixed device logic implemented in a hardware form that is employable in some embodiments to implement at least some aspects of the techniques described herein, such as to perform one or more instructions. Hardware includes components of an integrated circuit or on-chip system, an application-specific integrated circuit (ASIC), a field-programmable gate array (FPGA), a complex programmable logic device (CPLD), and other implementations in silicon or other hardware. In this context, hardware operates as a processing device that performs program tasks defined by instructions and/or logic embodied by the hardware and hardware utilized to store instructions for execution, e.g., the computer-readable storage media described previously.

Combinations of the foregoing are also employable to implement various techniques described herein. Accordingly, software, hardware, or executable modules are implementable as instructions and/or logic embodied on some form of computer-readable storage media and/or by one or more hardware elements 810. For example, the computer 802 is configured to implement particular instructions and/or functions corresponding to the software and/or hardware modules. Accordingly, implementation of a module executable by the computer 802 as software is achieved at least partially in hardware, e.g., through computer-readable storage media and/or hardware elements 810 of the processor 804. The instructions and/or functions are executable/operable by one or more articles of manufacture (for example, one or more computers 802 and/or processors 804) to implement techniques, modules, and examples described herein.

The techniques described herein are supportable by various configurations of the computer 802 and are not limited to the specific examples of the techniques described herein. This functionality is also implementable entirely or partially through a distributed system, such as over a “cloud” 814, as described below.

Cloud 814 includes and/or represents a platform 816 for resources 818. The platform 816 abstracts the underlying functionality of hardware (e.g., servers) and software resources of the cloud 814. For example, resources 818 include applications and/or data utilized while computer processing is executed on servers remote from the computer 802. In some examples, the resources 818 also include services provided over the Internet and/or through a subscriber network, such as a cellular or Wi-Fi network.

Platform 816 abstracts the resources 818 and functions to connect the computer 802 with other computing devices. In some examples, the platform 816 also serves to abstract scaling of resources to provide a corresponding level of scale to encountered demand for the resources implemented via the platform. Accordingly, in an interconnected device embodiment, the implementation of functionality described herein is distributable throughout system 800. For example, the functionality is partially implementable on computer 802 and via platform 816, which abstracts the functionality of cloud 814.

In general, functionality, features, and concepts described in relation to the examples above and below are employed in the context of the example procedures described in this section. Further, functionality, features, and concepts described in relation to different figures and examples in this document are interchangeable among one another and are not limited to implementation in the context of a particular figure or procedure. Moreover, blocks associated with different representative procedures and corresponding figures herein are applicable together and/or combinable in different ways. Thus, individual functionality, features, and concepts described in relation to different example environments, devices, components, figures, and procedures herein are usable in any suitable combinations and are not limited to the particular combinations represented by the enumerated examples in this description.

What is claimed is:

1. A method comprising:
receiving, by a processing device, an image of a subject person and a selection of a clothing item;
determining, using a machine-learning model, measurements of the subject person, the measurements relatable to one or more dimensions of the clothing item;
determining, using the machine-learning model, a fit of the clothing item on the subject person; and
displaying, by the processing device via a display, a representation of the fit of the clothing item on the subject person overlayed on a reproduced image of the subject person wearing the clothing item.

2. The method of claim 1, wherein the selection of the clothing item indicates a selected size of the clothing item.

3. The method of claim 1, wherein the method further comprises determining or looking up the one or more dimensions of the clothing item.

4. The method of claim 3, wherein the one or more dimensions of the clothing item include at least two of shoulder width, waist width, waist circumference, inseam length, hip circumference, sleeve length, collar opening diameter, chest width, or chest diameter.

5. The method of claim 1, wherein the machine-learning model comprises a parametric model that generates a representation of the subject person using a human mesh model with the measurements of the subject person.

6. The method of claim 5, wherein the parametric model is a skinned multi-person linear (SMPL) model.

7. The method of claim 5, wherein the machine-learning model further comprises a generative adversarial network that generates the reproduced image of the subject person wearing the clothing item based on the human mesh model.

8. The method of claim 7, wherein the image of the subject person is projected onto the human mesh model to generate the reproduced image.

9. The method of claim 8, wherein the clothing item is projected onto the reproduced image of the subject person.

10. The method of claim 1, wherein the representation of the fit of the clothing item indicates a looseness or tightness of the clothing item in multiple locations vis-à-vis the measurements of the subject person.

11. The method of claim 10, wherein the representation of the fit comprises a heat map with a fitting key.

12. The method of claim 10, wherein a textual summary of the fit of the clothing item is displayed along with the representation of the fit.

13. The method of claim 10, wherein a suggestion for a different size of the clothing item or a different clothing item with a better fit is displayed along with the representation of the fit.

14. The method of claim 1, wherein the reproduced image is three-dimensional (3D) configured to allow rotation of the reproduced image.

15. A computing device comprising:
a processing device; and
a computer-readable storage medium storing instructions that, responsive to execution by the processing device, causes the processing device to:
receive an image of a subject person and a selection of a clothing item;
determine, using a machine-learning model, measurements of the subject person, the measurements relatable to one or more dimensions of the clothing item;
determine, using the machine-learning model, a fit of the clothing item on the subject person; and
display, via a display, a representation of the fit of the clothing item on the subject person overlayed on a reproduced image of the subject person wearing the clothing item.

16. The computing device of claim 15, wherein the machine-learning model comprises a parametric model that generates a representation of the subject person using a human mesh model with the measurements of the subject person.

17. The computing device of claim 16, wherein the machine-learning model further comprises a generative adversarial network that generates the reproduced image of the subject person wearing the clothing item based on the human mesh model.

18. The computing device of claim 15, wherein the representation of the fit of the clothing item indicates a looseness or tightness of the clothing item in multiple locations vis-à-vis the measurements of the subject person via a heat map with a fitting key.

19. The computing device of claim 18, wherein a textual summary of the fit of the clothing item or a suggestion for a different size of the clothing item or a different clothing item with a better fit is displayed along with the representation of the fit.

20. One or more computer-readable storage media storing instructions that, responsive to execution by a processing device, causes the processing device to:
receive an image of a subject person and a selection of a clothing item;
determine, using a machine-learning model, measurements of the subject person, the measurements relatable to one or more dimensions of the clothing item;
determine, using the machine-learning model, a fit of the clothing item on the subject person; and
display, via a display, a representation of the fit of the clothing item on the subject person overlayed on a reproduced image of the subject person wearing the clothing item.
